(19) United States
(12) Patent Application Publication
(10) Pub. No.: US 2009/0102818 A1
(43) Pub. Date: Apr. 23, 2009

(54) METHOD AND DEVICE FOR ERROR-FREE KEYPAD INPUT

(75) Inventors: Xiang Xu, Nanjing (CH); Q.X. Li, Nanjing (CH); Zhaohui Li, Nanjing (CH); Kejiao Zhang, Nanjing (CH)

Correspondence Address: Mayback & Hoffman, P.A., 5722 S. Flamingo Road, #232, Fort Lauderdale, FL, 33330, US

(73) Assignee: MOTOROLA, INC., Schaumburg, IL (US)

(21) Appl. No.: 11/876,313

(22) Filed: Oct. 22, 2007

(51) Int. Cl. G06F 3/033

(52) U.S. Cl. 345/184

(57) ABSTRACT

A method of reducing user keypad errors includes sensing a user touch of a push button, storing a current state of the device in memory, displaying a graphic representing a new state of the device, where the new state corresponds to a press of the push button, and then sensing either a release of the push button or a press of the push button. The current state of the device is recalled from memory if a release of the push button sensed and the new state of the device is entered if a press of the push button is sensed.

### FIELD OF THE INVENTION

This invention relates in general to data entry and selections using a keypad on a wireless communication device, and more particularly, to a method and device for reducing errors when making selections or inputs using a keypad.

### BACKGROUND OF THE INVENTION

Communication between a user and his/her wireless device, e.g. a cellular phone, is performed almost exclusively through the device's keypad. Through the keypad, the user is able to enter and/or dial numbers, enter data, such as names, make menu selections, select available device modes, and effect other functions by manually pressing the keypad buttons. It is not uncommon for a user to press an incorrect button, particularly, as the size of wireless devices continue to decrease. This problem is exacerbated by the increase in device functionality and sophistication and is even more prevalent for the elderly and for those with poor eyesight or motor skills.

When an incorrect key is pressed, the user must correct the mistake by, in the case of an error in data entry, finding and pressing a delete key and then pressing the correct key. In the case of a mistake in pressing a function key, the user must correct the error by finding and pressing a back key or some other key for exiting the application. It is sometimes necessary to press further keys to return to the state the phone was in before the incorrect key push. Having to find and press additional buttons to correct mistaken key presses is annoying, inconvenient, and time consuming.

Therefore, a need exists to overcome the problems with the prior art as discussed above.

### SUMMARY OF THE INVENTION

A method is disclosed for reducing user keypad errors. The method includes sensing a user touch of a push button, storing a current state of the device in memory, displaying a graphic representing a new state of the device, where the new state corresponds to a press of the push button, and then sensing either a release of the push button or a press of the push button. The current state of the device is recalled from memory if a release of the push button sensed and the new state of the device is entered if a press of the push button is sensed.

In accordance with another feature, the method includes displaying the graphic representing the new state in a first location on a display in response to the touch of the button and displaying the graphic representing the new state in a second location on the display in response to the press of the button.

In accordance with a further feature, the step of displaying a graphic representing a new state of the device includes displaying the graphic representing the new state in a first font size on a display in response to the touch of the button and displaying the graphic representing the new state in a second font size on the display in response to the press of the button, the second font size being different than the first font size.

In accordance with yet another feature of the present invention, the touch of the press button is a first range of movement of the button and the press of the press button is a second range of movement of the button.

The present invention, according to an embodiment, provides determining the touch of the press button by measuring a capacitance.

In accordance with yet another additional feature of the present invention, a wireless device for reducing keypad errors includes at least one push button having a first state, a second state, and a third state, a first sensor operable to identify the push button being in the second state, a second sensor operable to identify the push button being in the third state, a memory for storing states of the device, a display, and a processor communicatively coupled to the first sensor, the second sensor, the memory, and the display. The processor is capable of receiving from the first sensor a signal indicating the push button being in the second state, storing a current state of a device in the memory, causing the display to display a graphic representing a new state of the device, the new state corresponding to the push button being in the second state. The processor is also capable of receiving either a signal from the first sensor indicating the push button returning to the first state or a signal from the second sensor indicating the push button being in the third state. The processor recalls the current state of the device from the memory in response to the first sensor indicating the push button returning to the first state and enters the new state of the device in response to the second sensor indicating the push button being in the third state.

The present invention, according to an embodiment, provides a method on a wireless device for reducing operator errors, where the method includes, in response to detecting a transition of a push button from a first state to a second state, storing in memory a current state of the device, placing the device in a temporary state corresponding to a function associated with the push button, and displaying a graphic associated with the temporary state of the device. In response to detecting a transition of the push button from the second state to the first state, the device recalls the current state of the device from the memory and in response to detecting a transition of the push button from the second state to a third state, the device designates the temporary state as the current state.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a front elevational view of a wireless communication device, according to an embodiment of the present invention.

FIG. 2 is a perspective view of a key and a block circuit diagram for reducing operator errors, according to an embodiment of the present invention.

FIG. 3 is a process flow diagram of a method for reducing operator errors, according to an embodiment of the present invention.

FIG. 4 is a fragmentary, front elevational view of a display previewing a character, according to an embodiment of the present invention.

FIG. 5 is a fragmentary, front elevational view of the display of FIG. 4 displaying the character previewed in FIG. 4 entered in an entry area, according to an embodiment of the present invention.

FIG. 6 is a fragmentary, front elevational view of the display of FIG. 5 previewing another character, according to an embodiment of the present invention.

FIG. 7 is a fragmentary, front elevational view of the display of FIG. 6 after the character previewed in FIG. 6 has been removed, according to an embodiment of the present invention.

FIG. 8 is a fragmentary, front elevational view of the display of FIG. 5, previewing a third character, according to an embodiment of the present invention.

FIG. 9 is a fragmentary, front elevational view of the display of FIG. 8 displaying the character previewed in FIG. 8 entered in the data entry area adjacent the character entered into the data entry area in FIG. 5, according to an embodiment of the present invention.

FIG. 10 is a fragmentary, front elevational view of a display showing a photograph, according to an embodiment of the present invention.

FIG. 11 is a fragmentary, front elevational view of the display of FIG. 10 previewing an enlarged portion of the photograph of FIG. 10, according to an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The present invention provides a method and device for reducing or eliminating the possibility of a user pressing an incorrect key and allows a user to correct an error without pressing any keys to do so. The novel keypad, according to one embodiment, provides a plurality of buttons that each have three states: an untouched state, a touched state, and a pressed state. The inventive keys are able to detect when a user's finger has made contact with a button and can display the entry to the user for confirmation that that is the selection that the user wishes to make. Once the user is confident that the key is indeed the correct key, the user is then able to apply pressure, place the key in the “pressed” state, and select the character or function corresponding to that that key.

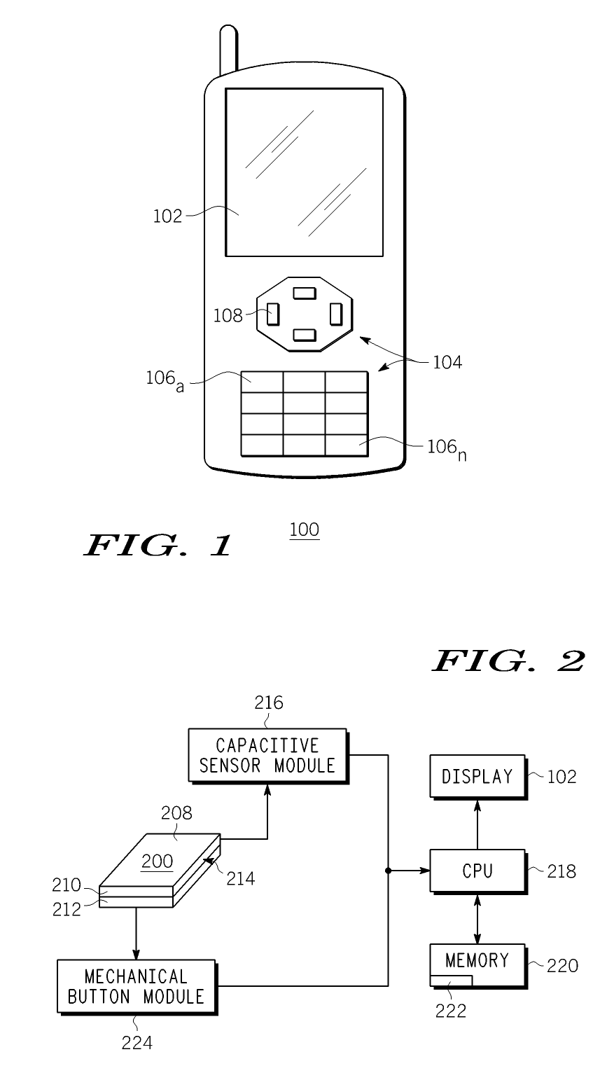

Referring now to FIG. 1, an exemplary electronic device 100 is shown The specific electronic device 100, depicted in FIG. 1, is a cellular telephone. As will be clear, however, the present invention is not so limited and can also be used with other wireless devices and non-wireless devices that are equipped with keypads and displays.

The cellular phone 100, as shown, includes a display 102. The display 102 produces graphical representations of characters, such as numbers, letters, and symbols and is able to render pictures and other graphical objects. Most commercially-available displays 102 are able to render graphics in multiple colors and provide high-quality resolution for uses such as playing video and/or displaying photographs. As a phone number is being dialed, the display 102 is most commonly used to show a phone number and, in some cases, an associated name entered into the device 100 for storage, or recalled.

The device 100 also has a keypad 104, which, in the illustrated exemplary embodiment, includes a number pad and a four-position rocker switch. The keypad 104 is a group of individual keys or buttons 106a-n that allow a user to interact with the device 100 and control any of several functions, such as menu selection, navigation, and data input. The keypad 104 not only includes the standard 12 number/letter keys on a phone 100, but can also include any function buttons 108 present on the device 100.

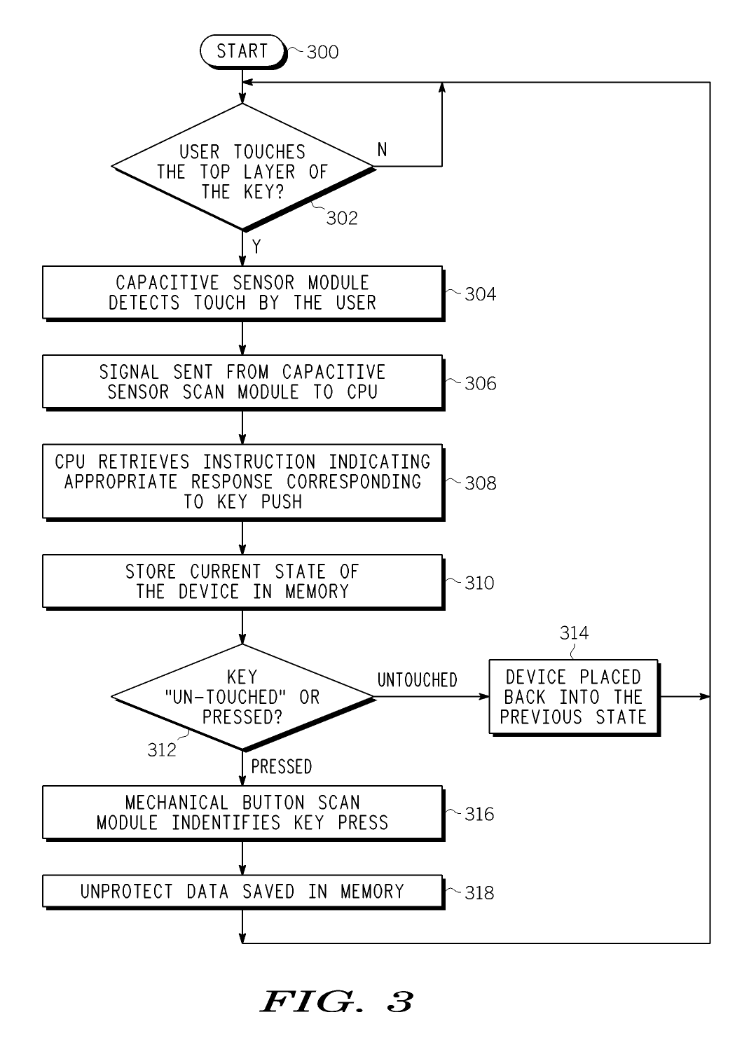

FIG. 2 shows one exemplary embodiment of a key or button 200 that is useful for implementation of the keypad 104 of the present invention and FIG. 3 shows an exemplary process flow for using the present invention. For ease of discussion, only the single key 200 is shown and described in FIG. 2. In practice, a keypad 104 will include a plurality of keys 200.

Each key 200, in this exemplary embodiment, has three main layers: a top layer 208 for making contact with a user's finger; an intermediate layer 210; and a bottom layer 212. In this implementation, the upper layer 208 and the intermediate layer 210 form two sides of a capacitor 214. Capacitive coupling is well known in the art and the details of which are not described here. What is to be understood is that a capacitance between the two plates 208 and 210 changes when a user has placed his/her finger on the upper layer 208.

The process flow of FIG. 3 begins at step 300 and moves directly to step 302 where a user touches the top layer 208 of the key 200. This “touch” by the user causes a change in the capacitance of the capacitor 214, which, in step 304, is detected by a capacitive sensor module 216. The detected change in capacitance is interpreted by the capacitive sensor module 216 as a possible key selection by the user. In step 306, a signal identifying the particular key is sent from the capacitive sensor module 216 to a central processing unit (CPU) 218, which indicates that a change in capacitance, and, therefore, a potential key press, has been detected for the identified key 200.

In one embodiment, in step 308, the CPU 218 will look in a memory 220 for an instruction indicating the appropriate state, or response, of the device that corresponds to an actual actuation of the identified key 200. The state could be displaying a graphic on the display 102 or could be causing a function to run. An example of a graphic could be a number or letter that the key 200 is assigned to on the keypad 104. An example of a function could be placing the device 100 in a camera mode and running a photo-taking or photo-viewing application. The state can also be sub-functions, such as, for example, a zoom-in/zoom-out function. Other functions can be running a software application, such as web browsers, games, calculators, calendars, and many others. However, before a function is started or a graphic is displayed on the display 102, the current state of the device 100, i.e., the current function being run by CPU 218, is, in step 310, stored in an area 222 of the memory 220. This memory storage 222 allows the CPU 218 to return to the previous state if it is later determined that the user did not intend to press the button 200. In step 312, the device 100 waits to see if the button 200 is going to be actuated, e.g., pressed further down (indicating that the user intended to press the button 200) or is not actuated, e.g., released (indicating that the user did not intend to press the button 200).

If the button 200 is released, the flow moves to step 314 where the state of the device stored in memory area 222 is recalled and the device is placed back into the previous state, returning the device 100 to where it was before the button 200 was touched. This advantageously allows the user to view the device's response to a key actuation before committing to the key actuation. Where a user would have to typically press several keys to guide the device back to its current state in prior-art devices, with the present invention, the user merely has to release the single touched button.

Below the capacitor 214 is a mechanical button 212, which is attached to a mechanical button module 224. Mechanical buttons are well known and include any switch that is activated or deactivated by a physical movement of the switch. The mechanical button module 224 senses physical movement of the mechanical button 212 (i.e., a “press”). Upon sensing physical movement of the mechanical portion 212 of the button 200, the flow moves from step 312 to step 316 where the mechanical button scan module 224 transmits a signal to the CPU 218 confirming that the key 200 was pressed. As stated above, once the mechanical portion 212 of the button 200 is depressed, it is assumed that the user intended to press that key. Therefore, when the CPU 218 receives a signal from the mechanical button module 224, it allows, in step 318, the saved state in memory area 222 to be unprotected or deleted. The flow then moves back up to step 302.

Although a capacitive/mechanical switch 200 is shown in FIG. 2 and described herein, the present invention is in no way limited to any particular type of switch. The switch 200 can be any two-state or two-position switch. This includes a mechanical on top of mechanical design, a capacitive on top of capacitive, any combination thereof, or any other switch technology that provides at least two switch positions so that a“touch” can be registered separate from a “press.” The present invention can also include a switch that is able to detect an amount of compression so that, for instance, a first range of movement constitutes a first state and a second range of movement constitutes a second state. For instance, if the entire range of movement of the button is a distance that is 10 units long, a first range of movement X, which constitutes the “touch” state, can be the first four units and a second range of movement Y can be the last six units.

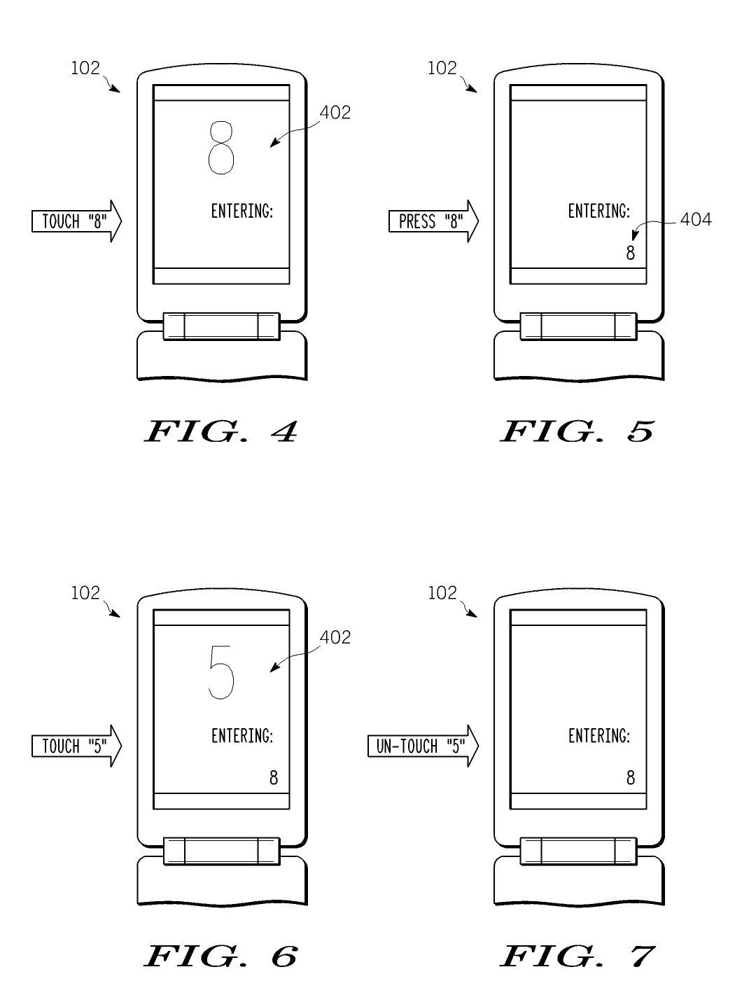

FIGS. 4-9 show the present invention in use on a device 100 during a number-entry process. FIG. 4 shows the response of the device 100 to a user touching, but not pressing, the button corresponding to an alphanumeric “8.” The device's response is to show the number 8 on its display 102. In this embodiment, the number 8 is shown in an area 402 of the screen 102 that is not typically the place where a number is displayed. By placing the number in this alternate area 402, the user can easily see the character that corresponds to the button the user has touched. This is especially true if the display is much larger in size than the display of the character when the button is fully pressed. If this is the correct character, the user can depress the button the rest of the way until the mechanical switch 212 registers a push. At that time, the number 8 moves “down,” as shown in FIG. 5, to its normal or expected area 404 on the screen 102 and is registered as a user entry. The present invention provides any method of displaying a graphic in a first state in response to a touch and a second state in response to a press of the key 200, where the states are different from each other. For example, the characters can be displayed in an enlarged font size, as is shown in FIG. 4, making them easier to see and to confirm that they are correct. Once the button 200 is pressed, the characters can return to their normal font size, as shown in FIG. 5.

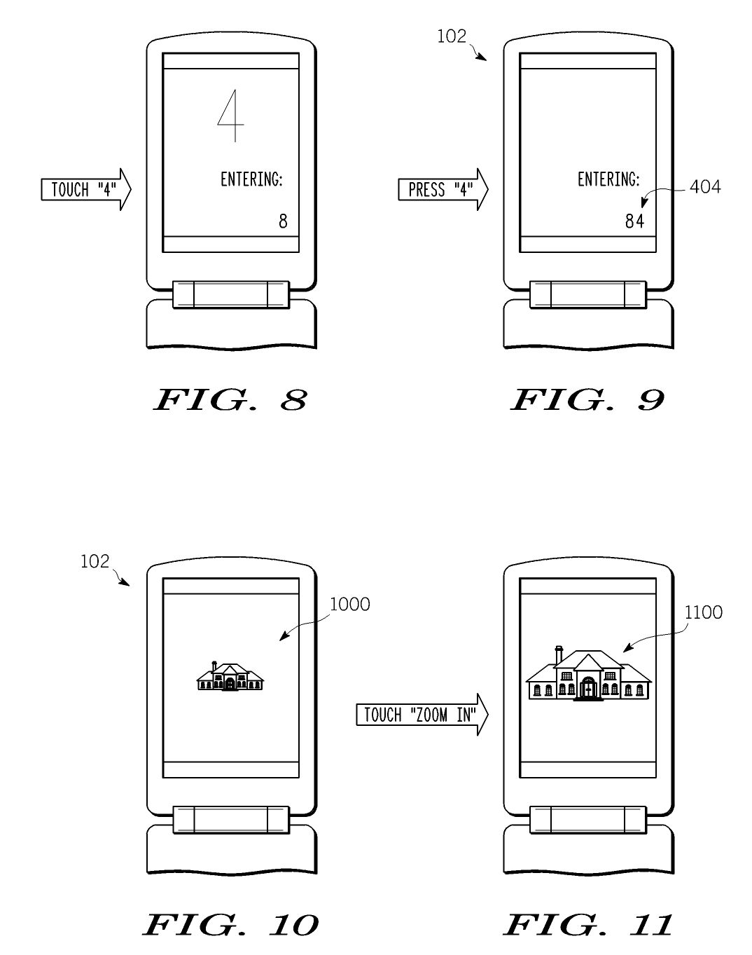

FIG. 6 shows the device's reaction to a user touching the number 5 button. In this case, the character “5” is displayed in the preview area 402 of the screen 102, just as the number 8 was previewed in FIG. 4. Upon realizing that number 4 button was the intended target, the user can simply move his/her finger off of the number 5 button and, as shown in FIG. 7, the character 5 will disappear from the screen 102. In FIG. 8, the preview area 402 indicated that the user touched the desired key, which is the number 4. Upon seeing the preview of the 4 character on the screen, the user presses the key until the mechanical switch 212 registers a press and, as shown in FIG. 9, the number 4 moves down next to the number 8 in the phone number area 404 of the display 102.

FIGS. 10-11 provide an example of a process where a function is sampled (i.e., not fulfilled but merely shown) using an embodiment of the present invention. FIG. 10 shows a device 100 in a picture display mode 1000. When a user touches a function button—the zoom button in this case—the display 102 shows the zoomed-in picture 1100 of FIG. 11. Upon realizing that the zoom button is not the intended target button, the user can release the button and the screen returns to the original display 1000 shown in FIG. 10.

Computer Program Product

In addition to the memory 220, CPU instructions may also be embedded in a computer program product, or computer readable medium, which comprises all the features enabling the implementation of the methods described herein, and which—when loaded in a computer system—is able to carry out these methods. Computer program in the present context means any expression, in any language, code or notation, of a set of instructions intended to cause a system having an information processing capability to perform a particular function either directly or after either or both of the following a) conversion to another language, code or, notation; and b) reproduction in a different material form.

The computer readable medium may include non-volatile memory, such as ROM, flash memory, disk drive memory, CD-ROM, SIM card, and other permanent storage. Additionally, a computer medium may include, for example, volatile storage such as RAM, buffers, cache memory, and network circuits.

The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

### CONCLUSION

As should now be clear, embodiments of the present invention provide an advantage over prior art devices by providing an electronic device that reduces the possibility of a user pressing an incorrect key, reduces the number of key presses to begin a function, and allows a user to correct errors without pressing any keys.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method of reducing user keypad errors, the method comprising:
sensing a user touch of a push button;
storing in memory a current state of a device;
displaying a graphic representing a new state of the device, the new state corresponding to a press of the push button;
sensing one of a release of the push button and a press of the push button;
recalling the current state of the device from the memory in response to sensing a release of the push button; and
entering the new state of the device in response to sensing the press of the push button.

2. The method according to claim 1, further comprising:
displaying the graphic representing the new state in a first location on a display in response to the touch of the button; and
displaying the graphic representing the new state in a second location on the display in response to the press of the button.

3. The method according to claim 1, wherein the displaying a graphic representing a new state of the device comprises:
displaying the graphic representing the new state in a first font size on a display in response to the touch of the button; and
displaying the graphic representing the new state in a second font size on the display in response to the press of the button, the second font size being different than the first font size.

4. The method according to claim 1, wherein:
the touch of the press button is a first range of movement of the button; and
the press of the press button is a second range of movement of the button.

5. The method according to claim 1, further comprising:
determining the touch of the press button by measuring a capacitance.

6. The method according to claim 1, further comprising:
determining the press of the press button by identifying a physical movement.

7. The method according to claim 1, further comprising:
executing an application representing the new state on a display in response to the touch of the button; and
removing the current state in response to the press of the button.

8. The method according to claim 7, wherein the application comprises one of:
a camera application;
a web browser application;
a picture view application; and
a sub-function.

9. A wireless device for reducing keypad errors, the device comprising:
at least one push button having a first state, a second state, and a third state;
a first sensor operable to identify the push button being in the second state;
a second sensor operable to identify the push button being in the third state;
a memory for storing states of the device;
a display; and
a processor communicatively coupled to the first sensor, the second sensor, the memory, and the display, the processor capable of:
receiving from the first sensor a signal indicating the push button being in the second state;
storing a current state of a device in the memory;
causing the display to display a graphic representing a new state of the device, the new state corresponding to the push button being in the second state;
receiving one of:
a signal from the first sensor indicating the push button returning to the first state; and
a signal from the second sensor indicating the push button being in the third state;
recalling the current state of the device from the memory in response to the first sensor indicating the push button returning to the first state; and
entering the new state of the device in response to the second sensor indicating the push button being in the third state.

10. The device according to claim 9, further comprising:
a first display portion for displaying the graphic representing the new state when the push button is in the second state; and
a second display portion for displaying the graphic representing the new state when the push button is in the third state.

11. The device according to claim 9, wherein the first state of the push button comprises:
a steady state of the push button.

12. The device according to claim 9, wherein:
the second state of the push button comprises:
a first range of movement of the button; and
the third state of the push button comprises:
a second range of movement of the button, the second range of movement being beyond than the first range of movement.

13. The device according to claim 9, wherein the push button comprises:
a capacitive portion.

14. The method according to claim 9, wherein the push button comprises:
a physically-moving portion.

15. A method on a wireless device for reducing operator errors, the method comprising:
in response to detecting a transition of a push button from a first state to a second state:
storing in memory a current state of the device;
placing the device in a temporary state corresponding to a function associated with the push button; and
displaying a graphic associated with the temporary state of the device;
in response to detecting a transition of the push button from the second state to the first state:
recalling the current state of the device from the memory; and
in response to detecting a transition of the push button from the second state to a third state:
designating the temporary state as the current state.

16. The method according to claim 15, wherein the displaying a graphic associated with the temporary state of the device comprises:
displaying the graphic associated with the temporary state of the device in a first location on a display.

17. The method according to claim 16, wherein the designating the temporary state as the current state comprises:
displaying the graphic associated with the temporary state of the device in a second location on the display.

18. The method according to claim 17, wherein:
the displaying the graphic in the first location on the display comprises:
displaying the graphic in a first font size and
the displaying the graphic in the second location on the display comprises:
displaying the graphic in a second font size.

19. The method according to claim 15, wherein the displaying a graphic representing a new state of the device comprises:
displaying the graphic representing the new state in a first state on a display in response to the touch of the button; and
displaying the graphic representing the new state in a second state on the display in response to the press of the button, the second state being visually different than the first state.

20. The method according to claim 15, wherein:
the touch of the press button is a first range of movement of the button; and
the press of the press button is a second range of movement of the button.
